(19) United States
(12) Patent Application Publication
(10) Pub. No.: US 2011/0049872 A1
(43) Pub. Date: Mar. 3, 2011

(54) CONNECTIONS FOR EXPANDABLE TUBULARS

(76) Inventor: Jeffery A. Spray, Houston, TX (US)

(21) Appl. No.: 12/666,308

(22) PCT Filed: Jun. 27, 2008
(86) PCT No.: PCT/US08/68639

§ 371 Date: Nov. 15, 2010

Related U.S. Application Data
(60) Provisional application No. 60/937,802, filed on Jun. 29, 2007.

(51) Int. Cl. F16L 25/00; B23P 19/00

(52) U.S. Cl. 285/330; 29/428

(57) ABSTRACT

Embodiments disclosed herein relate to an expandable tubular connection and a method for connecting expandable tubular members to each other. The expandable tubular member includes a plurality of curved leaves, in which each of the leaves has a concave inner surface and a convex outer surface. The leaves are then attached to each other using and through attachment points such that the leaves are formed about an axis of the expandable tubular member. Connection members are then disposed upon the plurality of leaves. Each of the connection members is disposed upon one or more leaves, in which the connection members may be disposed upon or towards an end of the leaves and/or may be disposed upon the inner and outer surfaces of the leaves. The connection members from one expandable tubular member are configured to engage the connection members of another expandable tubular member.

### CROSS-REFERENCE TO RELATED APPLICATIONS

This application, pursuant to 35 U.S.C. §119(e), claims priority to U.S. Patent Application Ser. No. 60/937,802 filed on Jun. 29, 2007 and entitled “Couplings for Expandable Tubular” in the name of Jeffery A. Spray, which is hereby incorporated by reference in its entirety.

### BACKGROUND OF DISCLOSURE

1. Field of the Disclosure

Embodiments disclosed herein generally relate to expandable tubular members. More specifically, embodiments disclosed herein relate to connections and methods used to connect expandable tubular members.

2. Background Art

When joining segments of conduits and tubular members in an end-to-end manner for transporting fluid, such as fluid under pressure, typical threaded connections are usually used to form the connection between the conduits and tubular members. Oil field tubular goods generally use such threaded connections for connecting adjacent sections of conduit or pipe. These threaded connections usually include a male thread formed on a pin member and a female thread formed on a box member. This threaded connection may be made up by rotating the pin member with respect to the box member, in which the male thread and the female thread of the tubular members will engage.

As such, an important part of any connection is to create or maintain a seal within the connection to keep the conduit fluid pressure-tight and from leaking. Typically, connections will be designed to include elastomeric or metal-to-metal seals therein. Metal-to-metal seals have the advantage of not requiring gaskets or other additional sealing devices, which would typically have to be replaced periodically as the connections are coupled and uncoupled. Metal seals are created when contact pressure between two metal surfaces exceeds the fluid pressure to be sealed. These contact pressures may be created during make up of the connection. On the other hand, elastomeric seals have the advantage of not requiring a constant contact pressure between the metal surfaces of the pin and box members of a connection to maintain a seal.

More recently then, oilfield tubular members have been developed that may be radially expanded from their initial diameters after being installed for the intended application. These tubular members may be expanded using elastic and/or plastic deformation. If using elastic deformation, the deformation to the tubular members is usually reversible and the deformation is not permanent. On the other hand, if using plastic deformation, the deformation of the tubular members is permanent. With this deformation, traditional threads may not maintain a seal and/or strength across the connection between the expandable tubular members. Moreover, traditional threads may not even maintain a connection between the expandable tubular members. Accordingly, there exists a need for a connection that may be used to connect and maintain connection between expandable tubular members, such as during expansion of the tubular members.

### SUMMARY OF INVENTION

In one aspect, embodiments disclosed herein relate to an expandable tubular connection. The connection includes a first expandable tubular member and a second expandable tubular member. Each of the first expandable tubular member and the second expandable tubular member have an axis defined therethrough and include a plurality of curved leaves, each leaf having a concave inner surface and a convex outer surface, in which the plurality of curved leaves are disposed adjacent to each other about the axis, an attachment point that attaches one of the plurality of curved leaves to another of the plurality of curved leaves, and a plurality of connection members, each disposed on at least one of the plurality of curved leaves. The first expandable tubular member and the second expandable tubular member are configured to one of expand from a first diameter to a second larger diameter and contract from the second larger diameter to the first diameter. Further, the plurality of connection members of the first tubular member are configured to engage the plurality of connection members of the second tubular member.

In another aspect, embodiments disclosed herein relate to an expandable tubular member having a coupling connection and an axis defined therethrough. The member includes a plurality of curved leaves, each having a concave inner surface and a convex outer surface, in which the plurality of curved leaves are disposed adjacent to each other about the axis, an attachment point that attaches one of the plurality of curved leaves to another of the plurality of curved leaves, and a plurality of connection members, each disposed on at least one of the plurality of curved leaves. The plurality of connection members are configured to connect with another plurality of connection members disposed on another expandable tubular member and the expandable tubular member is configured to expand from a first diameter to a second larger diameter.

In yet another aspect, embodiments disclosed herein relate to a method of manufacturing an expandable tubular member. The method includes providing a plurality of curved leaves, in which each of the plurality of curved leaves comprises a concave inner surface and a convex outer surface, disposing a plurality of connection members on the expandable tubular member, in which each of the plurality of connection members is disposed on at least one of the plurality of curved leaves, and attaching the plurality of curved leaves to each other with at least one attachment point such that the plurality of curved leaves are disposed adjacent to each other about an axis and the expandable tubular member is configured to expand from a first diameter to a second larger diameter.

Further, in yet another aspect, embodiments disclosed herein relate to a method of connecting a first expandable tubular member to a second expandable tubular member. The method includes providing the first expandable tubular member and the second expandable tubular member, each having a plurality of curved leaves, each of the plurality of curved leaves having a concave inner surface and a convex outer surface, in which the plurality of curved leaves are disposed adjacent to each other about an axis of the expandable tubular member. Each of the first expandable tubular member and the second expandable tubular member further include an attachment point that attaches one of the plurality of curved leaves to another of the plurality of curved leaves and a plurality of connection members, each disposed on at least one of the plurality of curved leaves. The method then further includes engaging the plurality of connection members of the first expandable tubular member with the plurality of connection members of the second expandable tubular member.

Other aspects and advantages of the invention will be apparent from the following description and the appended claims.

### BRIEF DESCRIPTION OF DRAWINGS

FIGS. 1A and 1B show multiple views of an expandable tubular member in accordance with embodiments disclosed herein.

FIG. 2 shows a cross-sectional view of an expandable tubular member in accordance with embodiments disclosed herein.

FIGS. 3A and 3B shows planar cross-sectional views of an expandable tubular connection in accordance with embodiments disclosed herein.

FIG. 4 shows a planar cross-sectional view of an expandable tubular connection in accordance with embodiments disclosed herein.

FIGS. 5-7 show multiple views of curved leaves in accordance with embodiments disclosed herein.

FIGS. 8-13 show multiple views of curved leaves in accordance with embodiments disclosed herein.

FIGS. 14-16 show multiple views of curved leaves in accordance with embodiments disclosed herein.

FIG. 17 shows a planar cross-sectional view of an expandable tubular connection in accordance with embodiments disclosed herein.

FIG. 18 shows a sectional view of an expandable tubular connection in accordance with embodiments disclosed herein.

FIG. 19 shows a planar cross-sectional view of an expandable tubular connection in accordance with embodiments disclosed herein.

FIG. 20 shows a planar cross-sectional view of an expandable tubular connection in accordance with embodiments disclosed herein.

FIG. 21 shows a planar cross-sectional view of an expandable tubular connection in accordance with embodiments disclosed herein.

FIG. 22 shows a planar cross-sectional view of an expandable tubular connection in accordance with embodiments disclosed herein.

FIG. 23 shows a planar cross-sectional view of an expandable tubular connection in accordance with embodiments disclosed herein.

FIG. 24 shows an above end view of expandable tubular members in accordance with embodiments disclosed herein.

FIGS. 25-28 show multiple stylistic views of sleeves in accordance with embodiments disclosed herein.

### DETAILED DESCRIPTION

Specific embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the invention. However, it will be apparent to one of ordinary skill in the art that the embodiments disclosed herein may be practiced without these specific details. In other instances, well-known features have not been described in detail to avoid unnecessarily complicating the description.

In one aspect, embodiments disclosed herein relate to an expandable tubular connection and a method for connecting expandable tubular members to each other. The expandable tubular member includes a plurality of curved leaves, in which each of the leaves has a concave inner surface and a convex outer surface. These leaves may have a linear surface, such as a smooth surface, or a non-linear surface, such as a helical surface. The leaves are then attached to each other using and through attachment points such that the leaves are formed about an axis of the expandable tubular member. This expandable tubular member may expand from a smaller first diameter to a larger second diameter.

A plurality of connection members are disposed upon the plurality of leaves. The connection members may be formed upon the leaves, or the connection members may be manufactured separately and attached (e.g., joined) to the leaves. Each of the connection members is disposed upon one or more leaves, in which the connection members may be disposed upon or towards an end of the leaves and/or may be disposed upon the inner and outer surfaces of the leaves. The connection members from one expandable tubular member are configured to engage the connection members of another expandable tubular member.

As described herein, the present disclosure may be used within the production of hydrocarbons, such as oil and gas. For example, the present disclosure may be used within water wells, dewatering wells, monitoring and remediation wells, tunnels, shafts, pipelines, and other similarly known tubular applications. Further, the present disclosure is related to tubular members. As used herein, “tubular” refers to any structure that may be generally round, generally oval, and/or generally elliptical. Further, these tubular members may be completely solid, or may include perforations therein, such as present within sand screens, or these tubular members may be continuous, such as continuous coil tubing. Accordingly, these structures may be incorporated into the embodiments disclosed herein.

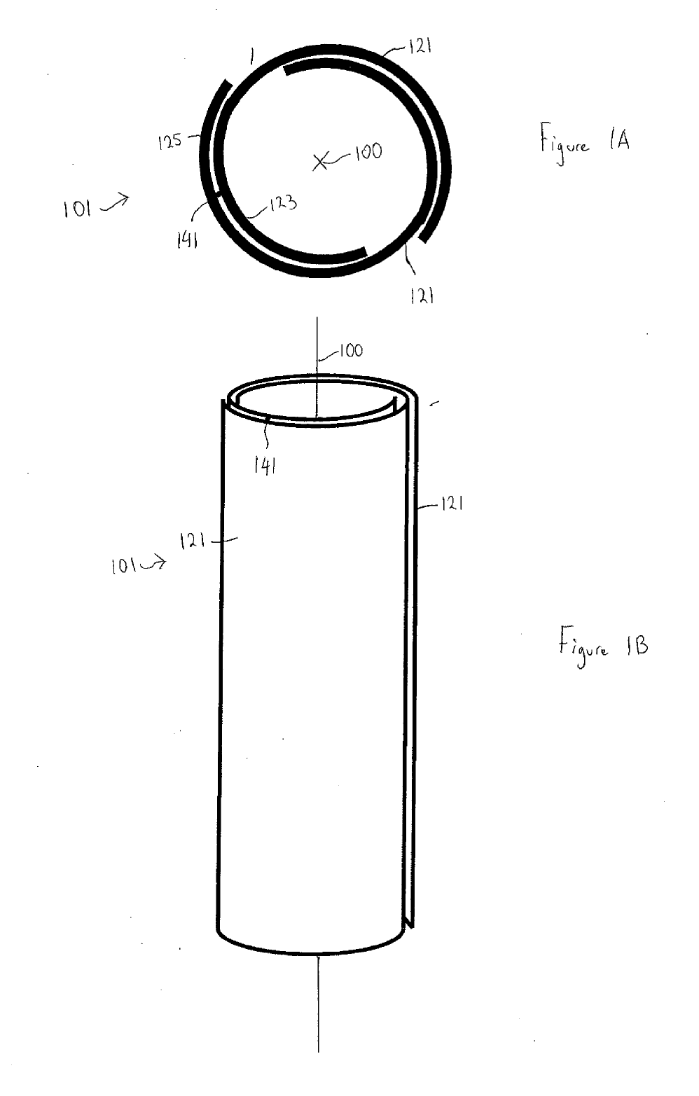

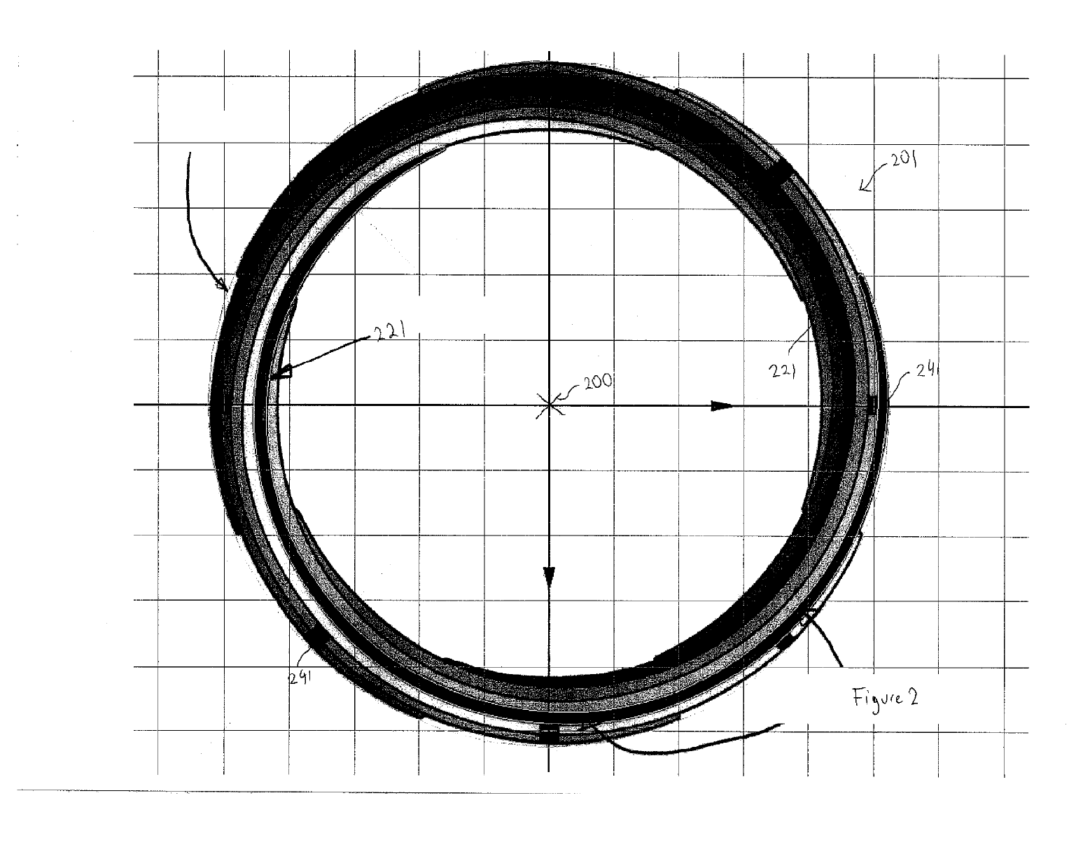

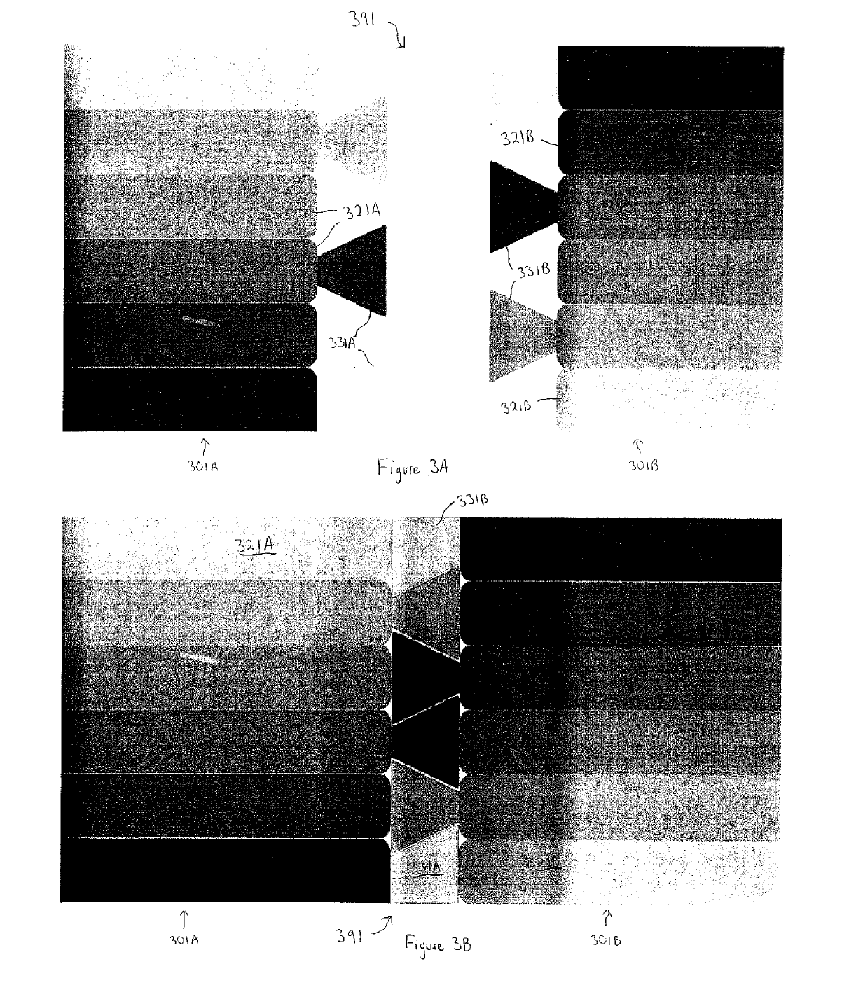

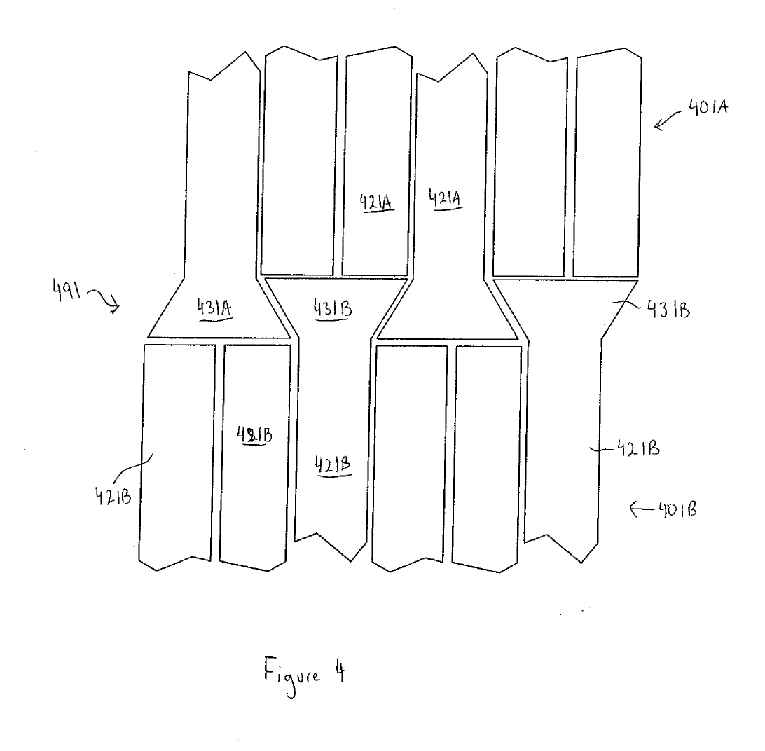

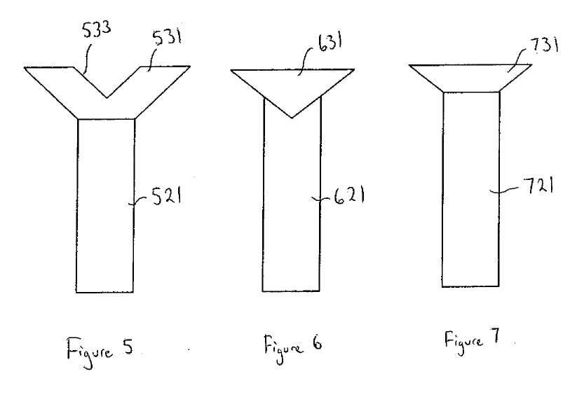

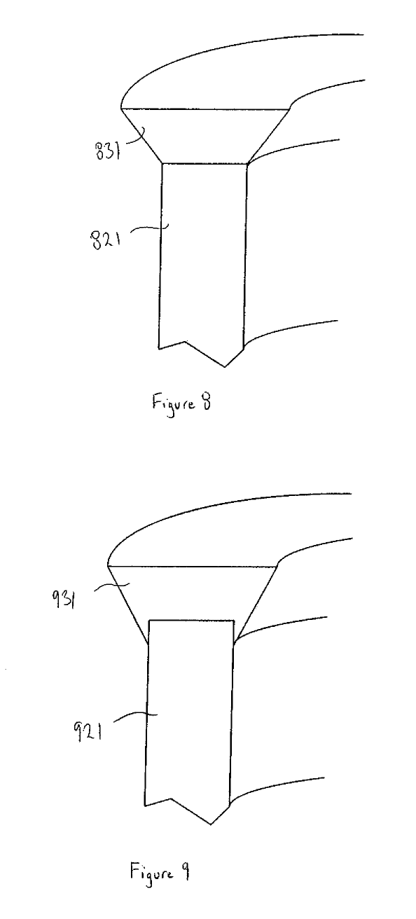

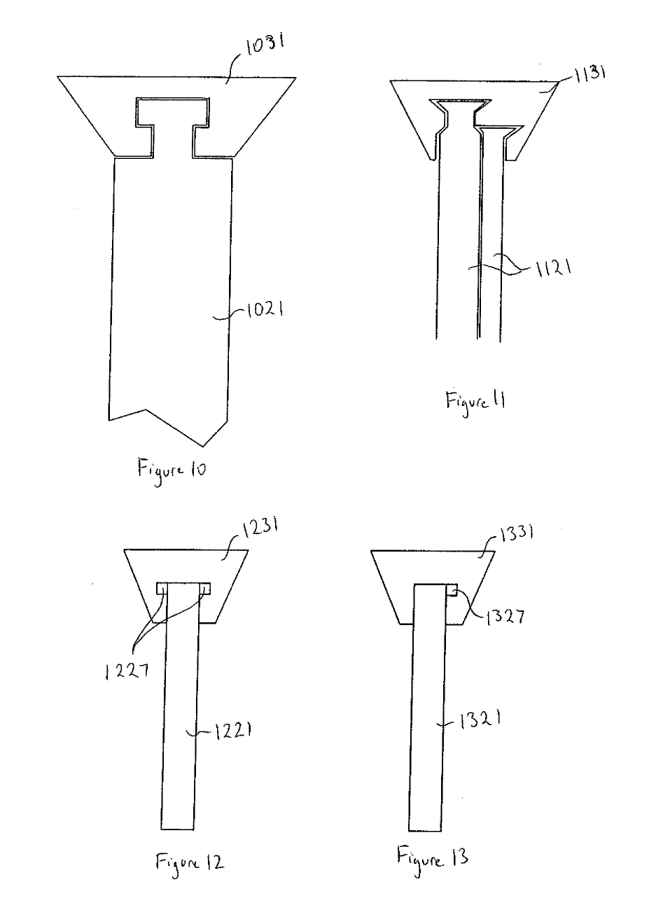

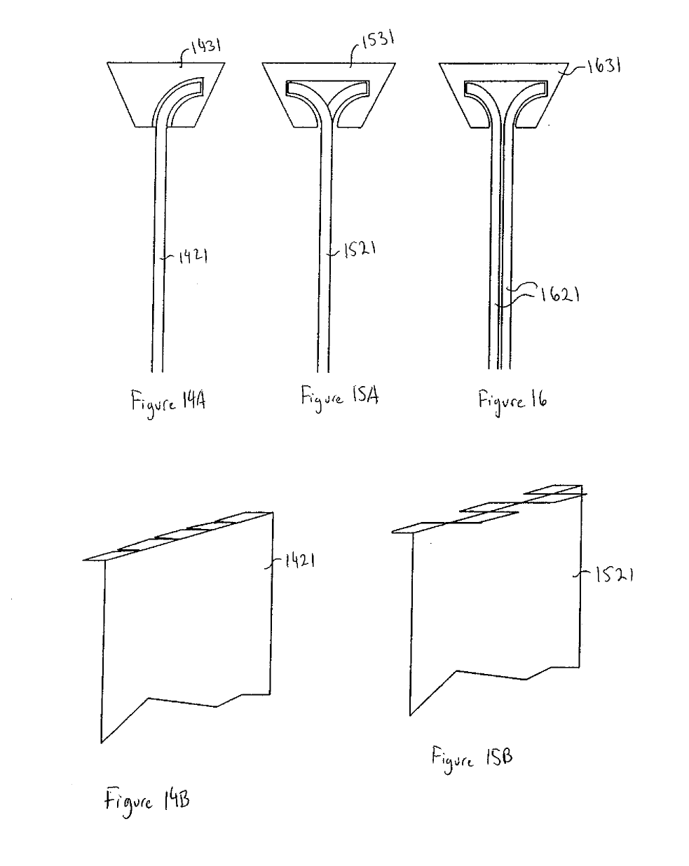

Referring now to FIGS. 1A and 1B, multiple views of an expandable tubular member 101 in accordance with embodiments disclosed herein are shown. In FIG. 1A, a cross-sectional view of the expandable tubular member 101 is shown. In FIG. 1B, a perspective view of the expandable tubular member 101 is shown. The expandable tubular member 101 includes multiple curved leaves 121. In this embodiment, the expandable tubular member 101 only includes two curved leaves 121. However, those having ordinary skill in the art will appreciate that the present disclosure is not so limited, and the expandable tubular member may have any number of curved leaves.

Each of the curved leaves 121 includes at least one concave inner surface 123 and at least one convex outer surface 125. The leaves 121 are arranged and attached to each other such that the leaves 121 form the expandable tubular member 101 about an axis 100. As such, the curved leaves 121 may form an arc or a spiral about the axis 100 of the expandable tubular member 101. Further, the leaves 121 may be attached to each other using one, or more, attachment points 141 (discussed more below), in which the leaves 121 may deflect radially inwards and outwards, slide against, and move with respect to each other for the expandable tubular member 101 to increase and decrease in diameter (e.g., expand or contract in size).

Referring now to FIG. 2, a cross-sectional view of an expandable tubular member 201 having an axis 200 defined therethrough in accordance with embodiments disclosed herein is shown. The expandable tubular member 201 includes multiple curved leaves 221 attached to each other using multiple attachment points 241. Specifically, in this embodiment, each attachment point 241 is used to attach two curved leaves 221 to each other. The attachment points 241 may include one or more of the following materials, devices, and/or methods: a joining material, such as a weld material, adhesive material, a braze material, and/or a solder material to join the curved leaves 221 to each other; an elastomeric material, such as by using an elastomer or elastomeric strip to attach the curved leaves 221 to each other; a mechanical fastener, such as by using a clamp to attach the curved leaves 221 to each other; an interference fit, such as by using an interference between the surfaces of the curved leaves 221 to attach the curved leaves 221 to each other; and/or may include any other method or material known in the art to attach the curved leaves to each other.

Further, as shown, the leaves 221 may have a non-uniform thickness to facilitate the expansion and contraction of the expandable tubular member 201. In this embodiment, each of the leaves 221 decreases in thickness from the outside of the expandable tubular member 201 moving radially inward with respect to the axis 200. As such, during expansion of the expandable tubular member 201, the curved leaves 221 may slide against each other as each of the leaves 221 expand radially outward. Conversely, during contraction of the expandable tubular member 201, the curved leaves 221 may slide against and/or move with respect to each other as each of the leaves 221 contract radially inward. Other similar expandable tubular members are described in U.S. Patent Application No. 60/832,530 and PCT Application No. PCT/US07/06193.

Referring now to FIGS. 3A and 3B, planar cross-sectional views of an expandable tubular connection 391 in accordance with embodiments disclosed herein are shown. The expandable tubular connection 391 includes two expandable tubular members 301A, 301B, in which FIG. 3A shows the expandable tubular members 301A, 301B disconnected from each other, and FIG. 3B show the expandable tubular members 301A, 301B connected to each other.

The expandable tubular members 301A, 301B each include multiple curved leaves 321A, 321B and multiple connection members 331A, 331B. As shown, each connection member 331A, 331B is disposed upon one of the curved leaves 321A, 321B, respectively. Specifically, in this embodiment, each connection member 331A, 331B is disposed on an end of one of the curved leaves 321A, 321B. Further, the connection members 331A, 331B may be disposed on the curved leaves 321A, 321B such that a gap is maintained between the connection members 331A, 331B of the respective expandable tubular members 301A, 301B. For example, as shown, the connection members 331A may be disposed on alternating curved leaves 321A such that a gap is formed between the connection members 331A of the expandable tubular member 301A.

As such, the connection members 331A of the expandable tubular member 301A may engage the connection members 331B of the expandable tubular member 301B. For example, the connection members 331A, 331B may be aligned and the tubular members 301A, 301B may be rotated and/or otherwise moved (e.g., radial or longitudinal movement) with respect to each other. The connection members 331A, 331B may then engage each other to form a connection 391 between the expandable tubular members 301A, 301B. This connection 391 may be used to secure the expandable tubular members 301A, 301B to each other, in addition to providing an engagement that may withstand operating pressures of the tubular members 301A, 301B and/or a seal between the tubular members 301A, 301B. Further, this connection 391 may be used to allow the curved leaves 321A, 321B of the expandable tubular members 301A, 301B to slide and move along each other when the expandable tubular members 301A, 301B are expanding and contracting, while still maintaining strength for the connection 391. Furthermore, this connection 391 may also be used to allow the connection members 331A, 331B to rotate relative to each other when the expandable tubular members 301A, 301B are expanding and contracting, while still maintaining strength for the connection 391.

Referring now to FIG. 4, a planar cross-sectional view of an expandable tubular connection 491 in accordance with embodiments disclosed herein is shown. The expandable tubular connection 491 includes an expandable tubular member 401A connected to an expandable tubular member 401B. Each of the expandable tubular members 401A, 401B has multiple curved leaves 421A, 421B, respectively. Further, as shown, connection members 431A, 431B are disposed on the curved leaves 421A, 421B, respectively. In this embodiment, each connection member 431A, 431B is disposed on an end of one of the curved leaves 421A, 421B.

Similar to the connection 391 shown in FIGS. 3A and 3B, the connection 491 in FIG. 4 has the connection members 431A, 431B disposed on the curved leaves 421A, 421B such that a gap is maintained between the connection members 431A, 431B of the respective expandable tubular members 401A, 401B. In this embodiment, however, rather than having the connection members 431A, 431B disposed on alternating curved leaves 421A, 421B, the connection members 431A, 431B may instead be disposed on every third curved leaf 421A, 421B. When the expandable tubular members 401A, 401B connect, the connection members 431A, 431B still engage each other to form and establish the connection 491. For example, as shown, by having the connection members 431A, 431B disposed on the ends of the curved leaves 421A, 421B, each connection member 431A, 431B may abut or be disposed adjacent the ends of two curved leaves 421A, 421B of the opposing expandable tubular member 401A, 401B.

Though, in the above embodiments, the expandable tubular members are shown as having the connection members disposed on alternating leaves, or on every third curved leaf, those having ordinary skill in the art will appreciate that the present disclosure is not so limited, and in other embodiments the connection members may be disposed on other arrangements of the curved leaves. For example, in one embodiment, the connection members may be disposed on every fourth leaf, in which the connection members may abut the ends of three leaves of the opposing expandable tubular member. Further, in another embodiment, the connection members may have be disposed on alternating leaves, in addition to having other connection members disposed on every third or fourth leaf. As such, in these embodiments, the connection members may be arranged and disposed on the leaves of the expandable tubular members such that the connection members engage each other to form a connection between the expandable tubular members. Furthermore, to increase the strength of the engagement between the connection members, the leaves with connection members disposed thereon may be attached to or formed with the leaves not having connection members disposed thereon.

Referring now to FIGS. 5-7, multiple views of curved leaves 521-721 in accordance with embodiments disclosed herein are shown. Each of the curved leaves 521-721 includes a connection member 531-731 disposed thereon. Specifically, in this embodiment, each of the connection members 531-731 is disposed on an end of each of the curved leaves 521-721. As shown, each of the connection members 531-731 may have a dovetail shape to increase the engagement between the connection members 531-731 when connecting expandable tubular members to each other. By using connection members that have dovetail shapes, the connection members on opposing expandable tubular members may be able to engage each other by having similar shaped connection members provided on the curved leaves complimentary to the expandable tubular members.

In FIGS. 5 and 7, the connection members 531, 731 each have a trapezoidal shape, in which the narrower end of the connection members 531, 731 are disposed on the curved leaves 521, 721. The connection member 531 disposed on the curved leaf 521 may further include a groove 533 formed therein. In this embodiment, the groove 533 is formed within en end, specifically the wider end, of the connection member 531. The groove 533 may be used to provide relief for the connection member 531, such as stress relief, when the connection member 531 is engaged with other connection members of another expandable tubular member, or may be used in other manners, such as to fit seals within an expandable tubular member or create interference with another expandable tubular member.

In FIG. 6 then, the connection member 631 may have a triangular shape, in which the narrower end of the connection member 631 may be disposed on the curved leaf 621. Further, the end of the curved leaf 621 may have a groove formed therein, in which the connection member 631 may then be disposed within the groove of the curved leaf.

As described above, the connection members are disposed on the curved leaves of the expandable tubular members to form an expandable tubular connection. As such, the connection members may be disposed on the curved leaves using a number of methods. For example, in one or more embodiments, the connection members may be attached to the curved leaves of the expandable tubular members. As shown in FIG. 8, a connection member 831 having a trapezoidal shape may have the narrower end of the connection member 831 attached to the end of the curved leaf 821. As shown in FIG. 9, a connection member 931 may have a groove formed therein, in which the end of the curved leaf 931 then fits within the groove of the connection member 931 to attach to the connection member 931.

Further, the curved leaves of the expandable tubular members may have features formed therein or attached thereto that facilitate the attachment of the connection members with the curved leaves. For example, as shown in FIGS. 10-13, an interference fit between connection members 1031-1331 and the attachment features of curved leaves 1021-1321 may be used to attach the connection members 1031-1331 and the curved leaves 1021-1321. In FIG. 10, grooves may be formed on one or more of the side surfaces of the curved leaf 1021, in which the connection member 1031 may then have a shape corresponding to the grooves of the leaf 1021 also formed therein. As such, the connection member 1031 may attach to the curved leaf 1021 using an interference fit or other methods known in the art (e.g., sliding engagement).

In FIG. 11, multiple leaves 1121 adjacent to each other may be used together, such as by having corresponding shapes and grooves formed within the curved leaves 1121. The connection member 1131 may then have a shape corresponding to both of the curved leaves 1121 disposed adjacent to each other, in which the connection member 1131 may then attach to both curved leaves 1121 using an interference fit.

In FIGS. 12 and 13 then, rather than forming grooves and features within the curved leaves (as shown in FIGS. 10 and 11), rails 1227, 1327 may be attached to the curved leaves 1221, 1321 to form an interference fit between the curved leaves 1221, 1321 and the connection members 1231, 1331. In FIG. 12, the curved leaf 1221 has multiple rails 1227 attached to both sides, in which the connection member 1231 has a shape corresponding to the rails 1227 formed therein. In FIG. 13, the curved leaf 1321 has only one rail 1327 attached thereto, in which the connection member 1331 has a shape corresponding to the one rail 1327 formed therein.

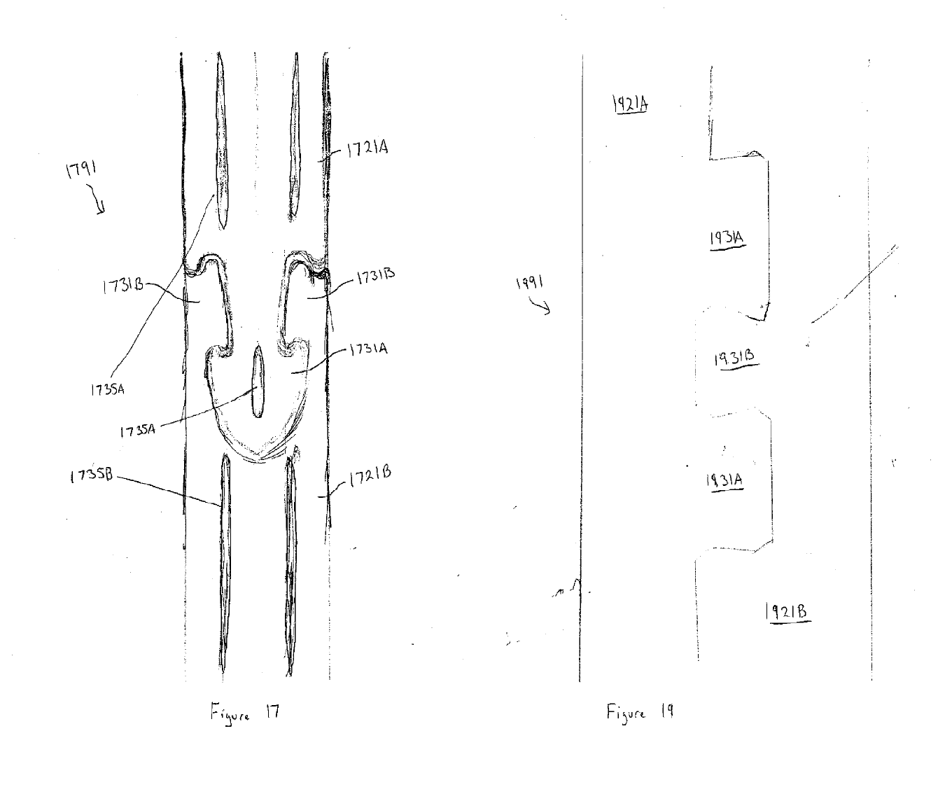

Furthermore, rather than forming grooves and attaching rails to the curved leaves to create an interference fit, the end of the curved leaves may instead be bent to create an interference fit. For example, as shown in FIGS. 14-16, ends, or portions thereof, of the curved leaves 1421-1621 may be bent when forming an interference fit with connection members 1431-1631. In FIGS. 14A and 14B, the end of the curved leaf 1421 is bent in a single direction to attach the connection member 1431 thereto. The connection member 1431 has a shape formed therein corresponding to the bent end of the curved leaf 1421, in which the connection member 1431 may then be disposed on the curved leaf 1421. In FIGS. 15A and 15B, the end of the curved leaf 1521 is bent in multiple directions, specifically two directions, to attach the connection member 1531 thereto. The connection member 1531 then has a shape formed therein corresponding to the bent end of the curved leaf 1521, in which the connection member 1531 may then be disposed on the curved leaf 1521. Further, in FIG. 16, rather than only using one curved leaf, the ends of multiple curved leaves 1621 are bent, in which the end of each curved leaf 1621 is bent in a single direction opposing the end of the other curved leaf 1621. The connection member 1631 then has a shape formed therein corresponding to the bent ends of the curved leaves 1621.

When attaching the connection members on the curved leaves, the connection members may be secured to the ends of the curved leaves, or the connection members may instead be able to slide and move with respect to the curved leaves (such as when the connection members use interference fit to attach to the curved leaves). If the connection members are secured to the curved leaves, numerous materials and methods may be used to attach the connection members upon the curved leaves. The attachment may include one or more of the following materials, devices, and/or methods: a joining material (such as a weld material, adhesive material, a braze material, and/or a solder material); an elastomeric material; a mechanical fastener; an interference fit; and/or may include any other method, mechanisms, or material known in the art.

Further, in addition to attaching the connection members on the curved leaves, the connection members may be monolithically formed with the curved leaves. For example, rather than having the connection members individually attached to the curved leaves, the connection members may be formed within the curved leaves during manufacturing. The connection members may be formed, for example, by using an extrusion process having a die that forms the connection members, by using a filing or grinding process that forms the connection members, by using a removal, cutting, shaping, molding, or forging process, or by any other similar process known in the art.

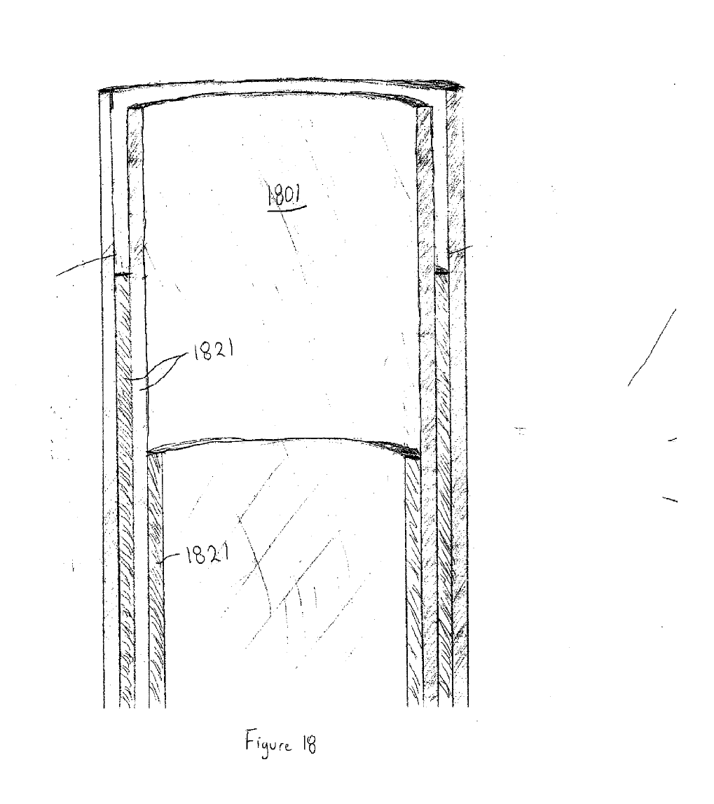

Referring now to FIG. 17, a planar cross-sectional view of an expandable tubular connection 1791 in accordance with embodiments disclosed herein is shown. In this embodiment, the connection 1791 includes a curved leaf 1721A of one expandable tubular member connecting with a curved leaf 1721B of another expandable tubular member. Those having ordinary skill in the art, though, will appreciate that the expandable tubular members of the connection may each include more than one curved leaf.

As shown, the curved leaf 1721A includes a connection member 1731A disposed thereon, and the curved leaf 1721B includes a corresponding connection members 1731B disposed thereon. In the above embodiments, the connection members generally used a dovetail shape to engage the connection members within a connection. However, in this embodiment, rather than using a dovetail shape, another “trapped” shape is used for the connection members. As used herein, a trapped shape refers to the shape of a connection member having a smaller base for attaching to a curved leaf, as compared to the main body of the connection member. This trapped shape may be used to create interference and engagement between the connection members of curved leaves when connecting two or more expandable tubular members to each other. Accordingly, a trapped shape may engage on both sides of the connection member, or only one side of the connection member. Further, as shown, the curved leaves 1721A, 1721B and/or the connection members 1731A, 1731B may include voids 1735A, 1735B formed therein. The voids 1735A, 1735B may be formed within the connection 1791 to provide relief, such as stress, bending, and/or interference relief, for the curved leaves 1721A, 1721B and/or connection members 1731A, 1731B when the connection members 1731A, 1731B are engaged with each other. Further, the voids may be filled, or at least partially filled, with a material disposed therein. This material may then have different material characteristics, such as a higher or smaller modulus of elasticity or yield strength, as compared to the materials used for the expandable tubular member to adjust and vary the qualities of the expandable tubular members.

Referring now to FIG. 18, a sectional view of an expandable tubular member 1801 in accordance with embodiments disclosed herein is shown. The expandable tubular member 1801 includes multiple curved leaves 1821 attached to each other. In the above embodiments, the ends of the curved leaves have been arranged substantially in-line and flush with each other so as to form a planar end surface for the expandable tubular member. In this embodiment, however, the ends of the curved leaves 1821 may be arranged with respect to each other such that a planar end surface is not formed for the expandable tubular member 1801. Specifically, as shown, one or more of the curved leaves 1821 may extend out further longitudinally than other curved leaves 1821, thereby forming gaps between the ends of some of the curved leaves 1821. As such, rather than having connection members disposed on the ends of the curved leaves, other arrangements of the connection members may be used to connect these expandable tubular members.

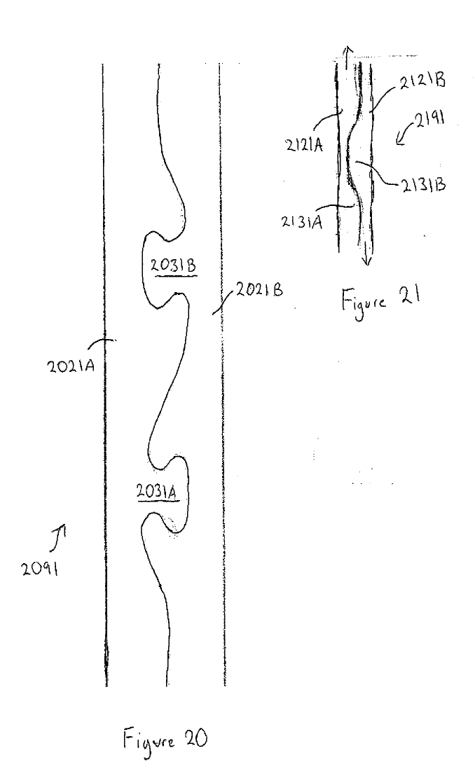

Referring now to FIG. 19, a planar cross-sectional view of an expandable tubular connection 1991 in accordance with embodiments disclosed herein is shown. In this embodiment, the connection 1991 includes a curved leaf 1921A of one expandable tubular member connecting with a curved leaf 1921B of another expandable tubular member. As shown, the curved leaf 1921A includes one or more connection member 1931A disposed thereon, and the curved leaf 1921B includes one or more corresponding connection members 1931B disposed thereon.

In the above embodiments, the connection members have been disposed on the ends of the curved leaves to connect expandable tubular members. In this embodiment, though, the connection members 1931A, 1931B are, instead, disposed on side surfaces of the curved leaves 1921A, 1921B. As such, the connection members 1931A of the curved leaf 1921A may be disposed on the concave inner surface of the curved leaf 1921A, and the connection members 1931B of the curved leaf 1921B may be disposed on the convex outer surface of the curved leaf 1921B. This may enable the connection members 1931A, 1931B to engage each other to form the connection 1991 between the two expandable tubular members. Further, this connection 1991 may be used with expandable tubular members that do not have a planar end surface formed thereon, such as the expandable tubular member 1801 shown in FIG. 18.

Referring now to FIG. 20, another planar cross-sectional view of an expandable tubular connection 2091 in accordance with embodiments disclosed herein is shown. In this embodiment, the connection 2091 includes a curved leaf 2021A of one expandable tubular member connecting with a curved leaf 2021B of another expandable tubular member. The connection members 2031A, 2031B may be disposed on side surfaces of the curved leaves 2021A, 2021B. Specifically, the connection members 2031A of the curved leaf 2021A may be disposed on the concave inner surface of the curved leaf 2021A, and the connection members 2031B of the curved leaf 2021B may be disposed on the convex outer surface of the curved leaf 2021B.

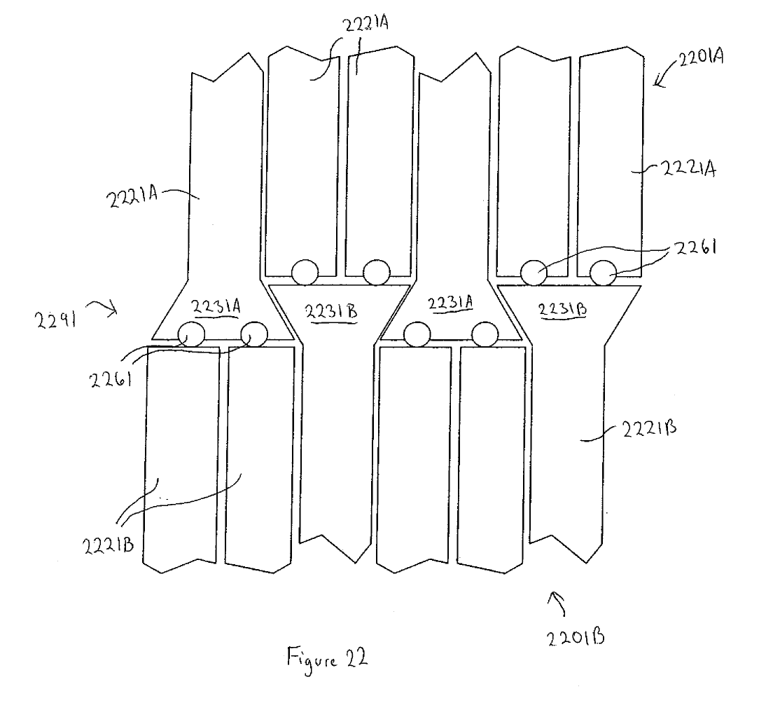

Referring now to FIG. 21, yet another planar cross-sectional view of an expandable tubular connection 2191 in accordance with embodiments disclosed herein is shown. The expandable tubular connection 2191 may include connection members 2131A, 2131B may be disposed on side surfaces of curved leaves 2121A, 2121B. In the above embodiments, the connection members had a trapped shape to assist in the connection of the expandable tubular members. However, in this embodiment, the connection members 2131A, 2131B instead have an “open” shape. As used herein, an open shape refers to the shape of a connection member having a larger base for attaching to a curved leaf, as compared to the main body of the connection member. Though this open shape may not create interference and/or engagement between the connection members when the curved leaves move radially away from each other, this open shape may still be used to create interference and engagement between the connection members of the curved when the curved leaves move longitudinally with respect to each other. Accordingly, the connection members may still be able to engage each other in at least one direction with respect to each other. Further, the curved leaves and the connection members disposed thereon may have convex surfaces, concave surfaces, or a combination of the two. Furthermore, the connection members may be disposed on a generally tapered surface such that the leaves taper at the ends thereof. Furthermore still, the connection members may be disposed on a reverse tapered surface such that the leaves are taper, with the larger ends of the taper disposed at the ends thereof.

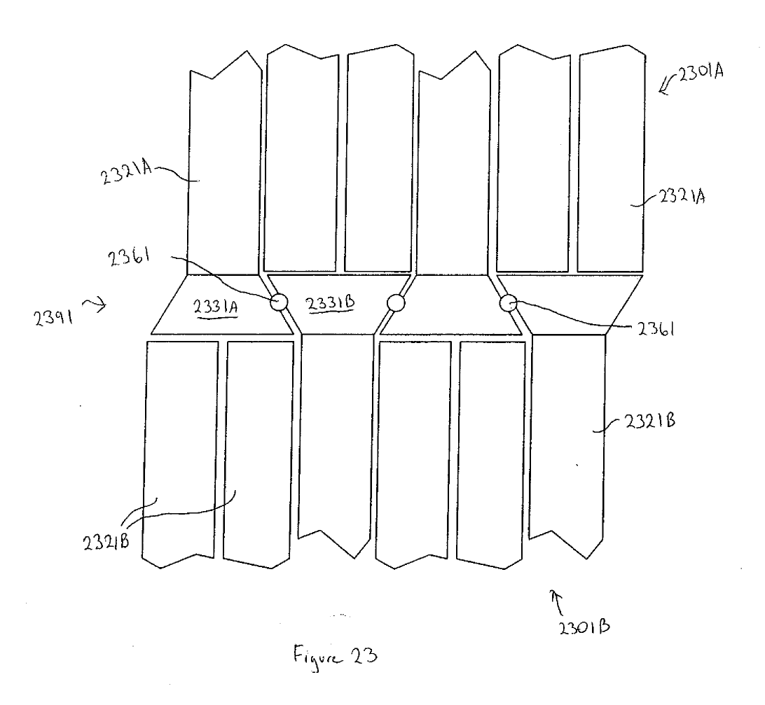

Referring now to FIGS. 22 and 23, planar cross-sectional views of expandable tubular connections 2291, 2391 are shown. The expandable tubular connections 2291, 2391 each include an expandable tubular member 2201A, 2301A connected to an expandable tubular member 2201B, 2301B. Each of the expandable tubular members 2201A, 2201B, 2301A, 2301B has multiple curved leaves 2221A, 2221B, 2321A, 2321B. As shown, connection members 2231A, 2231B, 2331A, 2331B are disposed on the curved leaves 2221A, 2221B, 2321A, 2321B. Further, the expandable tubular connections 2291, 2391 may include one or more seals 2261, 2361 disposed therein. The seals 2261, 2361 may be disposed within the expandable tubular connections 2291, 2391 to prevent fluid from leaking through the connections 2291, 2391.

In FIG. 22, the seals 2261 are disposed adjacent the ends of the connection members 2231A, 2231B. As such, the seals 2261 may form a seal between the ends of the connection members 2231A, 2231B and the respective opposing ends of the curved leaves 2221A, 2221B. These seals 2261 may be used when the connection 2291 is in compression and the expandable tubular members 2201A, 2201B are pushed into each other. In FIG. 23 then, the seals 2361 are disposed adjacent the sides of the connection members 2331A, 2331B. As such, the seals 2361 may form a seal between the sides of the connection members 2331A, 2331B when engaged with each other. These seals 2361 may be used when the connection 2391 is in tension and the expandable tubular members 2301A, 2301B are pulled away from each other.

Those having ordinary skill in the art will appreciate that, though the seals are shown as being disposed adjacent to the connection members within the expandable tubular connection, the present disclosure is not so limited, as the seals may be disposed in numerous locations. For example, in another embodiment, the seals may be disposed between the curved leaves of the expandable tubular members and still prevent leakage through the expandable tubular connections.

Further, those having ordinary skill in the art will appreciate that, though the seals are shown as having a circular cross-section, the present disclosure is not so limited, as the seals may have any cross-sectional shape known in the art. For example, in another embodiment, the seals may instead have a rectangular cross-section, a hollowed cross-section, or a “C” shaped cross-section without departing from the scope of the present disclosure. Furthermore, those having ordinary skill in the art will appreciate that the seals may be formed from any sealing material known in the art. For example, the seals may be formed from an elastic material, such as rubber or plastic, may be formed from metal, such as a soft metal to form a seal when compressed or deformed, or may even be formed from a combination of materials, such as a spring energized c-ring.

In one or more embodiments in accordance with the present disclosure, the connection members may be disposed upon the curved leaves such that the connection members extend about the entire circumference of the expandable tubular members. However, those having ordinary skill in the art will appreciate that the present disclosure is not so limited, and in other embodiments, the connection members may extend only over a portion of the circumference of the expandable tubular members.

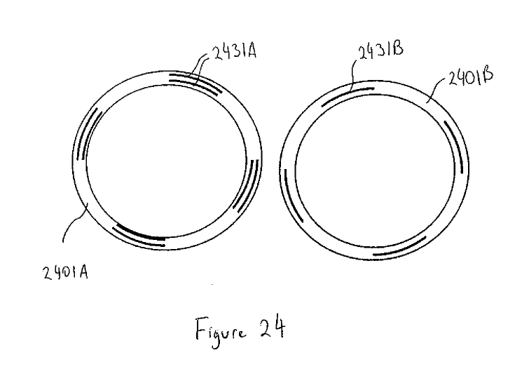

For example, as shown in FIG. 24, expandable tubular members 2401A, 2401B have connection members 2431A, 2431B disposed thereon, in which the connection members 2431A, 2431B only extend over a portion of the end of the tubular members 2401A, 2401B. When connecting the expandable tubular members 2401A, 2401B to each other, the portions of the tubular members 2401A, 2401B having connection members 2431A, 2431B disposed thereon may be aligned and disposed adjacent to the portions of the tubular members 2401A, 2401B not having connection members 2431A, 2431B disposed thereon. The tubular members 2401A, 2401B may then be rotated with respect to each other, in which the connection members 2431A, 2431B of the tubular members 2401A, 2401B may then engage each other and form a connection. Though connection members 2431A, 2431B are not disposed about the entire circumference of the expandable tubular members 2401A, 2401B, the connection between the expandable tubular members 2401A, 2401B may still form a seal therebetween to prevent leakage of fluid.

Further, in accordance with embodiments disclosed herein, sleeves and/or rings may be used with the expandable tubular connections to prevent leakage of fluid between the expandable tubular members and/or provide structural support for the expandable tubular connections. For example, a sleeve may be placed within an expandable tubular connection and expanded to contact the expandable tubular connection, or a sleeve may be placed about an expandable tubular connection and be contracted to contact the expandable tubular connection.

Referring now to FIGS. 25-28, multiple stylistic views of sleeves 2581-2881 in accordance with embodiments disclosed herein are shown. In FIG. 25, the sleeve 2581 includes a sealing material 2583 disposed about an outer surface of the sleeve 2581. In FIG. 26, the sleeve 2681 includes a seal 2685, such as an o-ring, disposed about an outer surface of the sleeve 2681. This seal 2685 may be disposed within a groove formed within the sleeve 2681. With the seals 2685 and sealing material 2583 disposed on an outer surface of the sleeves 2581, 2681, these sleeves 2581, 2681 may be used as internal sleeves to be disposed within an expandable tubular connection.

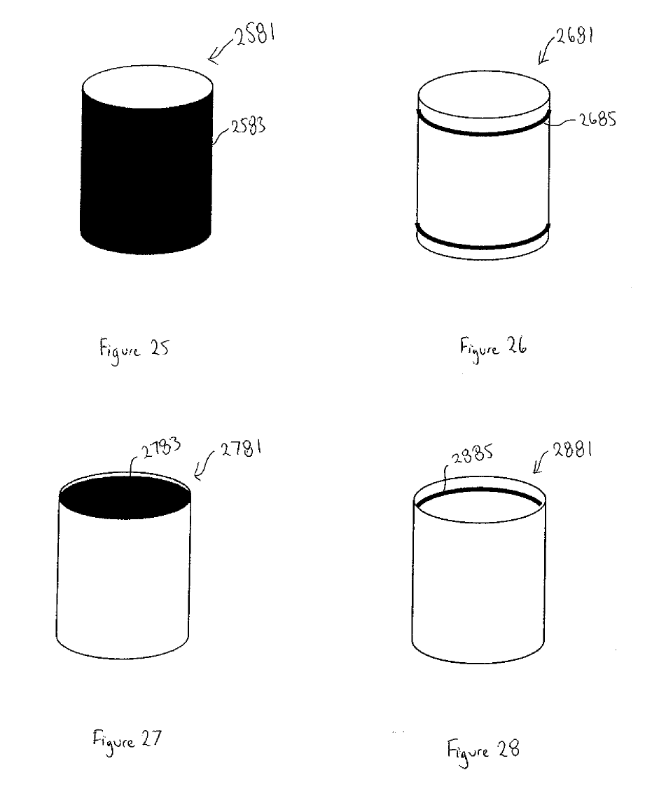

In FIG. 27 then, the sleeve 2781 includes a sealing material 2783 disposed within an inner surface of the sleeve 2781. In FIG. 28, the sleeve 2881 includes a seal 2885, such as an o-ring, disposed within an inner surface of the sleeve 2881. This seal 2885 may be disposed within a groove formed within the sleeve 2881. With the seals 2885 and sealing material 2783 disposed within an inner surface of the sleeves 2781, 2881, these sleeves 2781, 2881 may be used as external sleeves to be disposed about an expandable tubular connection.

The sleeves may then be manufactured using a variety of different materials and methods. For example, the sleeves may be formed from or include a high strength material, such as metal, elastomer, or composite materials (e.g., carbon fiber or Kevlar). The sealing material may then be disposed about the outer surface of the sleeves, such as by having the sealing material melted about, sprayed upon, wound upon, or otherwise disposed upon a sleeve. This may create a sleeve that has high strength in tension to provide structural support for expandable tubular connections, in addition to having sealing capabilities to prevent leakage of fluid between the expandable tubular members.

Accordingly, embodiments disclosed herein may provide for one or more of the following advantages. First, embodiments disclosed herein may be used to connect to each other expandable tubular members formed from curved leaves. By disposing a connection member upon the curved leaves of an expandable tubular member, the expandable tubular may then connect with a corresponding expandable tubular member. Next, embodiments disclosed herein may provide sealing engagement across a connection between expandable tubular members. By disposing a seal between connection members of expandable tubular members, an expandable tubular connection may prevent leakage of fluid therebetween. Finally, embodiments disclosed herein may increase the strength of the connection between expandable tubular members. For example, by disposing a sleeve about or within an expandable tubular connection, the strength of the connection may be increased and/or enhanced to evenly distribute stress thereabout.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. An expandable tubular connection, comprising:
a first expandable tubular member and a second expandable tubular member, each having an axis defined therethrough and comprising:
a plurality of curved leaves, each having a concave inner surface and a convex outer surface, wherein the plurality of curved leaves are disposed adjacent to each other about the axis;
an attachment point that attaches one of the plurality of curved leaves to another of the plurality of curved leaves; and
a plurality of connection members, each disposed on at least one of the plurality of curved leaves;
wherein the first expandable tubular member and the second expandable tubular member are configured to one of expand from a first diameter to a second larger diameter and contract from the second larger diameter to the first diameter;
wherein the plurality of connection members of the first tubular member are configured to engage the plurality of connection members of the second tubular member.

2. The expandable tubular connection of claim 1, wherein the plurality of connection members of the first expandable tubular member are disposed adjacent to an end thereof, and wherein the plurality of connection members of the second expandable tubular member are disposed adjacent to an end thereof.

3. The expandable tubular connection of claim 1, wherein at least one of the plurality of connection members of the first expandable tubular member is disposed on an end of one of the plurality of curved leaves of the first expandable tubular member, and wherein at least one of the plurality of connection members of the second expandable tubular member is disposed on an end of one of the plurality of curved leaves of the second expandable tubular member.

4. The expandable tubular connection of claim 3, wherein the at least one of the plurality of connection members of the first expandable tubular member is configured to engage the at least one of the plurality of connection members of the second expandable tubular member.

5. The expandable tubular connection of claim 1, wherein at least one of the plurality of connection members of the first expandable tubular member is disposed on the concave inner surface of one of the plurality of curved leaves of the first expandable tubular member, and wherein at least one of the plurality of connection members of the second expandable tubular member is disposed on the convex outer surface of one of the plurality of curved leaves of the second expandable tubular member.

6. The expandable tubular connection of claim 5, wherein the at least one of the plurality of connection members of the first expandable tubular member is configured to engage the at least one of the plurality of connection members of the second expandable tubular member.

7. The expandable tubular connection of claim 1, wherein the attachment point comprises one of a joining material, a mechanical fastener, an interference fit, and an elastic element.

8. The expandable tubular connection of claim 1, wherein at least one of the plurality of connection members is monolithically formed with at least one of the plurality of curved leaves of the first expandable tubular member, and wherein at least one of the plurality of connection members is monolithically formed with at least one of the plurality of curved leaves of the second expandable tubular member.

9. The expandable tubular connection of claim 1, wherein at least one of the plurality of connection members is attached to at least one of the plurality of curved leaves of the first expandable tubular member, and wherein at least one of the plurality of connection members is attached to at least one of the plurality of curved leaves of the second expandable tubular member.

10. The expandable tubular connection of claim 9, wherein the attachment of the at least one of the plurality of connection members with the at least one of the plurality of curved leaves of the first expandable tubular member comprises one of weld material, a mechanical fastener, an interference fit, an adhesive material, a solder material, a braze material, and an elastic element.

11. The expandable tubular connection of claim 1, further comprising a seal configured to be disposed between the first expandable tubular member and the second expandable tubular member when connected.

12. The expandable tubular connection of claim 11, wherein the seal is disposed adjacent to one of the plurality of connection members of one of the first expandable tubular member and the second expandable tubular member.

13. The expandable tubular connection of claim 12, wherein the seal is disposed on an outer surface of the one of the plurality of connection members of the one of the first expandable tubular member and the second expandable tubular member.

14. The expandable tubular connection of claim 12, wherein the seal is disposed adjacent a side of the one of the plurality of connection members of the one of the first expandable tubular member and the second expandable tubular member.

15. The expandable tubular connection of claim 12, wherein the seal is disposed adjacent an end of the one of the plurality of connection members of the one of the first expandable tubular member and the second expandable tubular member.

16. The expandable tubular connection of claim 1, further comprising a groove formed within one of the first expandable tubular member and the second expandable tubular member.

17. The expandable tubular connection of claim 16, wherein the groove is formed within one of the plurality of connection members of one of the first expandable tubular member and the second expandable tubular member.

18. The expandable tubular connection of claim 1, further comprising a sleeve disposed adjacent an end of one of the first expandable tubular member and the second expandable tubular member when connected.

19. The expandable tubular connection of claim 18, wherein the sleeve is disposed adjacent the concave inner surface of one of the plurality of curved leaves of one of the first expandable tubular member and the second expandable tubular member.

20. The expandable tubular connection of claim 18, wherein the sleeve is disposed adjacent the convex outer surface of one of the plurality of curved leaves of one of the first expandable tubular member and the second expandable tubular member.

21. An expandable tubular member having a connection and an axis defined therethrough, comprising:
a plurality of curved leaves, each having a concave inner surface and a convex outer surface, wherein the plurality of curved leaves are disposed adjacent to each other about the axis;
an attachment point that attaches one of the plurality of curved leaves to another of the plurality of curved leaves; and
a plurality of connection members, each disposed on at least one of the plurality of curved leaves;
wherein the plurality of connection members are configured to connect with another plurality of connection members disposed on another expandable tubular member; and
wherein the expandable tubular member is configured to expand from a first diameter to a second larger diameter.

22. The expandable tubular member of claim 21, wherein at least one of the plurality of connection members is disposed on an end of one of the plurality of curved leaves.

23. The expandable tubular member of claim 21, wherein at least one of the plurality of connection members is disposed on one of the concave inner surface and the convex outer surface of one of the plurality of curved leaves.

24. The expandable tubular member of claim 21, further comprising a seal disposed adjacent to one of the plurality of connection members.

25. The expandable tubular member of claim 21, further comprising a groove formed within one of the plurality of connection members.

26. The expandable tubular member of claim 21, further comprising a void formed within one of the plurality of connection members.

27. A method of manufacturing an expandable tubular member, comprising:
providing a plurality of curved leaves, wherein each of the plurality of curved leaves comprises a concave inner surface and a convex outer surface;
disposing a plurality of connection members on the expandable tubular member, wherein each of the plurality of connection members is disposed on at least one of the plurality of curved leaves; and
attaching the plurality of curved leaves to each other with at least one attachment point such that the plurality of curved leaves are disposed adjacent to each other about an axis and the expandable tubular member is configured to expand from a first diameter to a second larger diameter.

28. The method of claim 27, wherein the disposing the plurality of connection members comprises forming at least one of the plurality of connection members on at least one of the plurality of connection members.

29. The method of claim 27, wherein the disposing the plurality of connection members comprises attaching at least one of the plurality of connection members to at least one of the plurality of connection members.

30. A method of connecting a first expandable tubular member to a second expandable tubular member, the method comprising:
providing the first expandable tubular member and the second expandable tubular member, each comprising:
a plurality of curved leaves, each having a concave inner surface and a convex outer surface, wherein the plurality of curved leaves are disposed adjacent to each other about an axis of the expandable tubular member;
an attachment point that attaches one of the plurality of curved leaves to another of the plurality of curved leaves; and
a plurality of connection members, each disposed on at least one of the plurality of curved leaves; and
engaging the plurality of connection members of the first expandable tubular member with the plurality of connection members of the second expandable tubular member.

31. The method of claim 30, further comprising:
expanding the first expandable tubular member and the second expandable tubular member from a first diameter to a second larger diameter.

32. The method of claim 30, wherein at least one of the plurality of connection members of the first expandable tubular member is disposed on an end of one of the plurality of curved leaves of the first expandable tubular member, and wherein at least one of the plurality of connection members of the second expandable tubular member is disposed on an end of one of the plurality of curved leaves of the second expandable tubular member.

33. The method of claim 30, wherein at least one of the plurality of connection members of the first expandable tubular member is disposed on the concave inner surface of one of the plurality of curved leaves of the first expandable tubular member, and wherein at least one of the plurality of connection members of the second expandable tubular member is disposed on the convex outer surface of one of the plurality of curved leaves of the second expandable tubular member.
